(19) United States
(12) Patent Application Publication
(10) Pub. No.: US 2018/0134269 A1
(43) Pub. Date: May 17, 2018

(54) Method for Testing a Brake System of a Vehicle

(71) Applicant: AVL LIST GMBH, Graz (AT)

(72) Inventors: Martin Monschein, Dobersdorf (AT); Helmut Kokal, Graz (AT); Gorka Arce Alonso, Graz (AT)

(73) Assignee: AVL LIST GMBH, Graz (AT)

(21) Appl. No.: 15/810,692

(22) Filed: Nov. 13, 2017

(30) Foreign Application Priority Data
Nov. 11, 2016 (AT) A 51025/2016

(51) Int. Cl. B60T 17/22; G01M 17/007; B60T 8/171; F16D 65/847

(52) U.S. Cl. CPC B60T 17/221; G01M 17/0074; F16D 2066/001; F16D 65/847; B60T 8/171

(57) ABSTRACT

The invention relates to a method for testing a brake system (B) of a vehicle (F), wherein simulation results are used for the adaptation of a test on a test stand (P). The object of the invention is to provide a method for improving the test of the brake system (B). In accordance with the invention, this is achieved by creating a first flow simulation model (S1) of the vehicle (F) from geometric data (G) and by creating a second flow simulation model (S2) of the test stand (P), and a first simulation result is calculated with at least one first input variable by using the first flow simulation model (S1), and a change (Δ) of at least one second input variable in the second simulation model (S2) is carried out until a second simulation result of the second simulation model (S2) is achieved which corresponds essentially to the first simulation result.

The invention relates to a method for testing a brake system of a vehicle, wherein simulation results are used for the adaptation of a test on a test stand.

In particular, flow simulation results are used to adapt the thermal behavior of the brake system in a test system.

To determine the behavior of the vehicle, simulations or tests are usually performed on the entire vehicle, or tests are carried out on individual components, as in the present case for the brake system of the vehicle.

An essential limiting criterion for the brake system is a maximum temperature of a brake component, such as a brake disk, in which damage or failure occurs. A cooling of the brake system is to ensure that the brake system does not reach this maximum temperature. However, it should not allow more cooling air to enter than necessary, as this increases the resistance of the vehicle.

The temperature increase due to the heat input as a result of friction has a significant influence on the brake system. The resulting heat is removed mainly by forced convection. The flow conditions around components of the brake system have an influence on convection.

Further influencing factors on the convection are the vehicle geometry, a longitudinal velocity of the vehicle, a driving height, a steering angle, side winds and an ambient temperature. The steering angle, crosswinds and ambient temperature are disregarded for carrying out the tests.

From DE 10 2011 076 270 A1 a method for testing and simulation of a wheel brake system is known. In this case, measurements are carried out in a test on the test track with a test vehicle to determine the flow conditions around the wheel brake system and to thus determine a cooling constant b. On the basis of these results, a brake cooling device is arranged on a test stand in order to achieve the determined cooling constant b also at the test stand. This should enable a realistic test. The disadvantage of this is that the implementation of a test on the test track is necessary for the purpose of adapting the conditions on the test stand. Such tests on the test track are complex, time-consuming and costly, and even small changes to the test vehicle can be carried out only with great effort. Tests of prototypes of the brake system are also associated with a certain safety risk for test drivers, the test vehicle or the track.

It is the object of the present invention to provide a method which avoids these disadvantages and provides a method for improving the test of the brake system already before tests on the test track.

This is achieved in accordance with the invention in that from geometry data a first flow simulation model of the vehicle is created, and a second flow simulation model of the test stand is created, and based on the first flow simulation model a first simulation result—in terms of thermal behavior of the brake system—is calculated with at least one first input variable, and a change of at least one second input variable in the second simulation model is performed until a second simulation result of the second simulation model, which substantially corresponds to the first simulation result, is achieved.

This has the advantage that no expensive and complex test on the test track is necessary to improve the method and to determine the true flow conditions.

By using these simulation models changes in the vehicle geometry or in the materials used can be incorporated quickly and can be carried out in a cost-effective manner.

An even better test result can be achieved if the at least one second input variable is set as at least one third input variable for a test in the test stand and the test is thus carried out.

Errors in the second simulation model can be detected particularly easily and quickly if the second simulation model is validated on the basis of the test. Input variables and simulation results are compared with the measured variables and with the assumptions made, thus detecting any deviations and sources of error.

A particularly easy-to-use simulation model can be achieved if at least a longitudinal velocity of the vehicle is set as a first input variable—preferably set as the longitudinal velocity curve of the vehicle—and enters into the calculation. The longitudinal velocity of the vehicle is easy to determine in a test and is directly related to the flow conditions around the brake system and significantly influences them.

It is favorable if at least one air mass flow is set as at least one second input variable, preferably a curve of an air mass flow, and enters into the calculation. This leads to the advantage that the flow conditions around the brake system can be easily influenced and their direct effect on the brake system can be checked.

The input variable “vehicle speed” results in the simplest case in an air mass flow, which is then set on the test stand. It is favorable to calculate several air mass flows from the vehicle speed, since this is more realistic compared to the vehicle.

In order to present the test or the simulation in a particularly clear and simple manner, it is advantageous if at least one first output variable is calculated as the first simulation result, wherein the at least one first output variable is preferably a first temperature of a brake component and particularly preferably a first temperature curve of the brake component.

In order to be able to provide simulation results for various braking maneuvers, it is favorable if the first simulation result is calculated with at least one first parameter for the first simulation model, which is preferably a braking power and particularly preferably a braking power curve. In another embodiment, the braking power or the braking power curve can be entered as a further input variable into the simulation.

In order to be able to provide second input variables for a series of tests with different starting points, it is favorable if a plurality of second input variables is determined on the basis of a plurality of first input variables and a characteristic curve is created therefrom. These characteristic curves are used as correction characteristic curves for the test stand.

The same advantage arises if, depending on at least one second parameter that enters into the first simulation model and the second simulation model, a characteristic map having a first input variable and a second input variable is created, wherein the geometry data and a ride height preferably represent parameters.

Geometry data mean the geometric dimensions of the vehicle, wherein attention is paid to the dimensions of the brake-relevant vehicle parts such as dimensions of the wheel arches, or dimensions and position of the air supply on the vehicle.

Ride height means the height above the travel route on which the vehicle is later operated in real mode.

In the following, the invention will be explained in more detail with reference to the non-limiting figures, wherein:

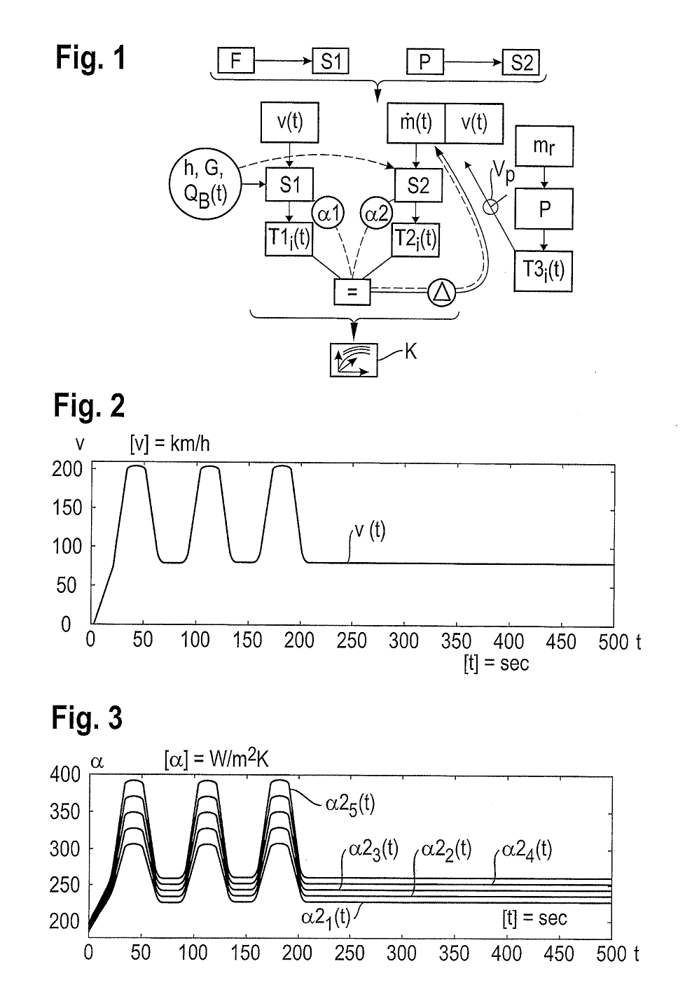

FIG. 1 shows a diagram of a method according to the invention;

FIG. 2 shows a diagram with a longitudinal velocity curve of the method according to the invention;

FIG. 3 shows a diagram of a progression of a heat transfer coefficient;

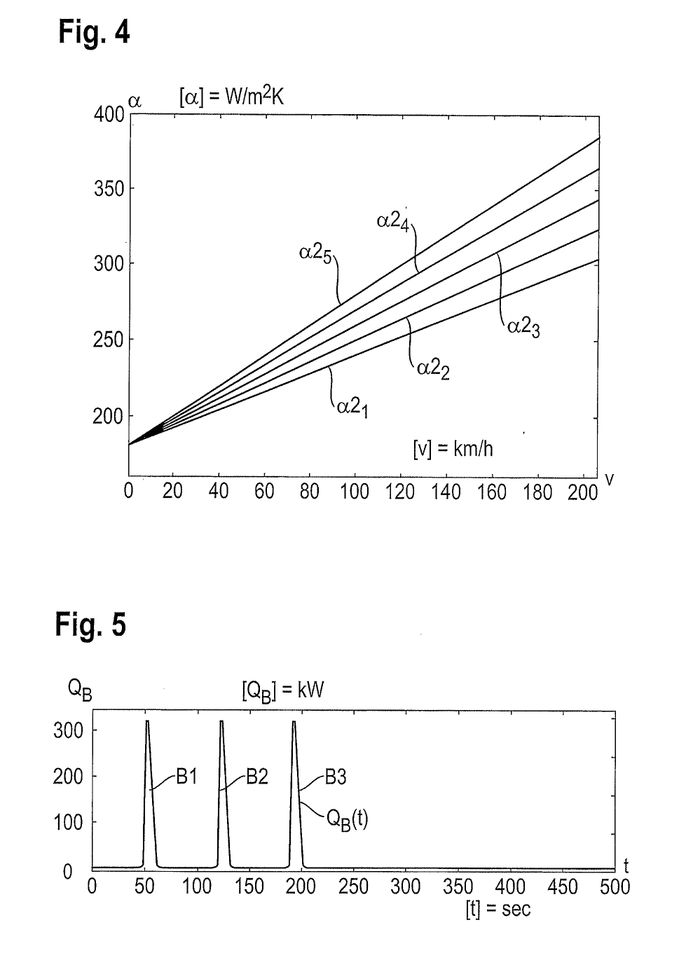

FIG. 4 shows a diagram of heat transfer coefficients over a longitudinal velocity of a vehicle;

FIG. 5 shows a diagram of a braking power curve;

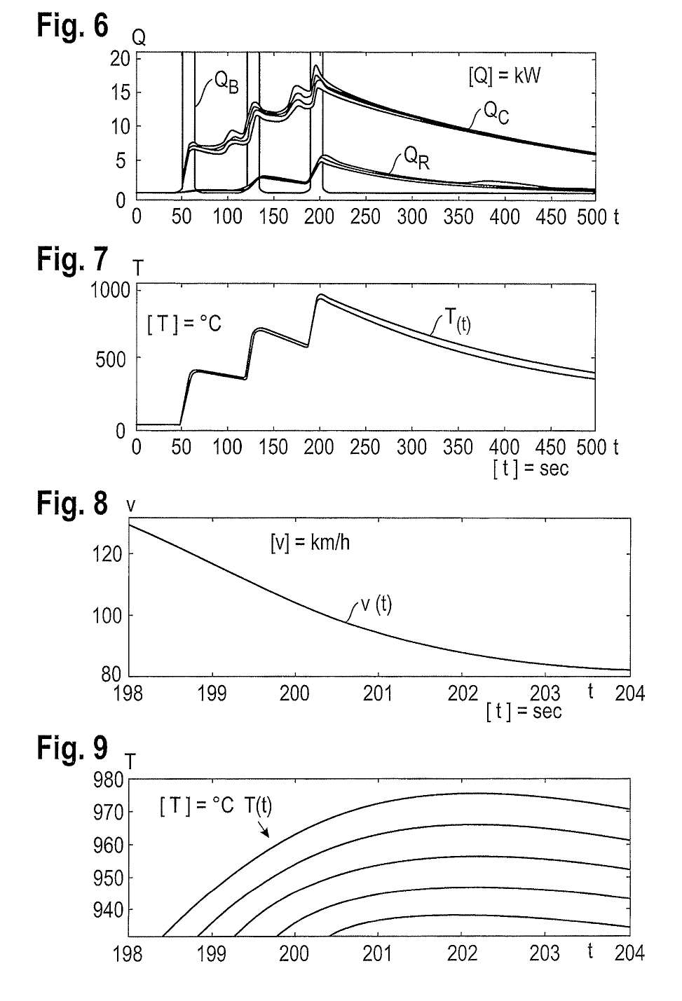

FIG. 6 shows a diagram of heat flows around a brake system;

FIG. 7 shows a diagram of first temperature curves of a brake component;

FIG. 8 shows a diagram of a section of the longitudinal velocity curve; and

FIG. 9 shows a diagram of the first temperature curves of the section analogous to FIG. 8.

In a method according to the invention for testing a brake system B of a vehicle F, as shown in FIG. 1, a first flow simulation model S1 is created from geometric data G of the vehicle F. From a test stand \dot{P} for testing the brake system B, a second flow simulation model S2 is created.

With the respective input variables such as the vehicle speed v is also meant the respective time-dependent variable, here the progression of the vehicle speed v(t). Instead of a single air mass flow \dot{m} it is usually necessary to provide a division into several air mass flows \dot{m}ᵢ to obtain better test results.

The vehicle speed v is entered as the first input variable in the first flow simulation model S1. Here it is also possible to additionally include other optional parameters such as the braking power \dot{Q}_{B} or the ride height h.

As a result of the first flow simulation model S1, the temperatures of the brake system T1ᵢ and the air mass flows \dot{m}1ᵢ are obtained, which result from the simulation data, such as the geometry data G of the vehicle F.

The vehicle speed v and the air mass flows \dot{m}2ᵢ are included as second input variables in the second flow simulation model S2. The air mass flows \dot{m}2ᵢ are variable and an influence is taken on the result of the second flow simulation model S2 by the variation of the air mass flows \dot{m}2ᵢ. As a result of the second flow simulation model S2, the temperatures of the brake system T2ᵢ are obtained.

Usually, the air mass flows \dot{m}1ᵢ do not correspond to the air mass flows \dot{m}2ᵢ. The temperatures of the brake systems T1ᵢ of the first flow simulation model S1 are compared with the temperatures of the brake systems T2ᵢ of the second flow simulation model S2. If the deviation of these two simulation results is greater than a maximum allowed error, the second input variable \dot{m}2ᵢ is subjected to a change Δ and the air mass flow \dot{m}2 is varied or regulated until the second simulation result S2 substantially corresponds to the first simulation result S1 in the comparison. This means that the second temperatures of the brake systems T2ᵢ correspond approximately to the first temperatures of the brake systems T1ᵢ, or the second temperature curve T2(t) corresponds approximately to the first temperature curve T1(t) and the deviation is smaller than the maximum allowed error. The results of the two simulation models S1 and S2 are now essentially the same.

Furthermore, it is possible, by using the heat transfer coefficients α1 and α2 analogously to the use of the temperatures T1, T2, to arrive at a corresponding result in the present method, which is shown in FIG. 1 as a dashed line. In this case, the heat transfer coefficients are compared and the air mass flows \dot{m}2ᵢ are changed analogously to the use of the temperatures T1, T2.

As a result of this procedure, at least one air mass flow \dot{m}2ᵢ is thus determined for the test stand P, which corresponds to the cooling of the brake system by the longitudinal velocity v of the vehicle F.

The second simulation model S2 can be subjected to a validation V_{P} by a test at the test stand P with a real air mass flow \dot{m}ᵣ, as shown in FIG. 1. In this case, a third temperature T3 is determined with this test on the real test stand P, which can also be included in the flow simulation model S2.

By changing the parameters such as the ride height h or the geometry data G, several characteristic curves can be created and from this a characteristic map K can be created.

FIGS. 2 to 9 show exemplary input variables and simulation results on the basis of diagrams. FIG. 2 shows a longitudinal velocity curve v(t). The longitudinal velocity v is given in km/h and a time t in seconds (sec). In this case, the vehicle F is accelerated from standstill (v=0 km/h) within the first 100 sec to over 200 km/h, driven a short time with constant longitudinal velocity and then decelerated to about 80 km/h and then driven again at a constant longitudinal velocity for about 30 seconds. Then the vehicle is again accelerated to over 200 km/h and the previous procedure repeated twice. After 200 sec, the vehicle is driven at a constant longitudinal velocity of 80 km/h.

In FIG. 3, the progression of the heat transfer coefficient α over the time t is shown. For this purpose, according to the invention, an air mass flow in was set as input variable at the longitudinal velocity v for the second simulation model S2 and accordingly subjected to a change Δ. Thus, the curves of the heat transfer coefficients α2₁(t), α2₂(t), α2₃(t), α2₄(t), α2₅(t) are obtained.

The heat transfer coefficient α is analogous to the velocity curve v(t) in FIG. 2, since it is assumed that the heat transfer coefficient α is linearly dependent on the velocity v. In FIG. 3 it can be seen that the heat transfer coefficient α varies in the illustrated exemplary embodiment at a velocity v of about 200 km/h between 300 W/m²K and 380 W/m²K, if the assumed air mass flow \dot{m} is subjected to the change Δ.

In FIG. 4, the heat transfer coefficient α is shown as a function of the velocity v.

By a first braking operation B1, a braking power Q_{B} is applied. The braking power curve Q_{B}(t) exceeds in each case 300 kW in the first braking operation B1, in a second braking operation B2 and in a third braking operation B3.

In FIG. 6, the transmitted heat is shown. In this case, the braking power Q_{B} is only shown up to 20 kW, but corresponds to its progression in FIG. 5. A heat Q_{C} transmitted by convection starts from zero and increases with the first braking operation B1 to about 7 kW and then drops again slightly and due to the increasing speed it increases before the second braking process B2 again until it rises sharply during the second braking process B2 and the process is repeated again. After the third braking process, in which the heat transmitted by convection fluctuates between 15 kW and 18 kW, it then decreases. Heat Q_{R} transmitted by radiation is negligible after the first braking operation B1, after the second braking process B2 it is about 3 kW and after the third braking process B3 it is about 5 kW. From this it can be seen that the heat transmitted by convection Q_{C} has the greatest influence on the temperature.

The braking power Q_{B} is calculated with the mass m of the vehicle F and the longitudinal velocity v to form

$${Q}_{B} = \frac{m \times {( \frac{V}{2} )}^{2}}{t}$$

The heat transmitted radiation heat Q_{R} is calculated with a surface area A of a surface O of the brake disk, an emissivity ε, the Stefan-Boltzmann constant σ, a surface temperature T_{O}, an ambient temperature T_{U} via

Q_{R}=A*ε*σ*(T_{O}⁴−T_{U}⁴).

The heat transmitted by convection Q_{C} is dependent on the heat transfer coefficient α and is calculated by the formula

Q_{C}=A*α*(T_{O}−T_{U}).

A temperature curve T(t) of the brake component shown in FIG. 7, i.e. the brake disk, increases to approximately 430° C. with the first braking operation B1 and to approximately 700° C. with the second braking operation B2 and to more than 930° C. with the third braking operation. The temperature T falls a little between the individual braking processes B1, B2, B3.

FIGS. 6, 7 and 9 show the curves of the other variables for the individual heat transfer coefficients α2₁(t), α2₂(t), α2₃(t), α2₄(t), α2₅(t).

The real air mass flow \dot{m}ᵣ depends on a diameter of a brake channel and on the velocity v. The invention provides a method for calculating or determining the required air mass flow \dot{m}.

By means of a heat balance around the brake disk, the unknown variables are determined in the first simulation model S1 and in the second simulation model S2. Heat is introduced into the brake disk by the braking power Q_{B}. The material and its geometry are known from the brake disk.

1. A method for testing a brake system (B) of a vehicle (F), wherein simulation results are used for adapting a test on a test stand (P), wherein a first flow simulation model (S1) of the vehicle (F) is created from geometric data (G), and a second flow simulation model (S2) of the test stand (P) is created, and based on the first flow simulation model (S1) a first simulation result is calculated with at least a first input variable, and a change (Δ) of at least one second input variable into the second simulation model (S2) is performed until a second simulation result of the second simulation model (S2) is achieved which substantially corresponds to the first simulation result.

2. The method according to claim 1, wherein at least one second input variable is set as at least one third input variable for a test in the test stand and the test is thus carried out.

3. The method according to claim 2, wherein on the test, the second simulation model (S2) is validated.

4. The method according to claim 1, wherein a longitudinal velocity (v) of the vehicle (F) is set at least as a first input variable, preferably as a longitudinal velocity curve (v(t)) of the vehicle (F), and enters into the calculation.

5. The method according to claim 1, wherein at least one air mass flow (\dot{m}), preferably a curve of an air mass flow (\dot{m}(t)), is set as at least one second input variable and enters into the calculation.

6. The method according to claim 1, wherein at least one first output variable is calculated as the first simulation result, wherein the at least one first output variable is preferably a first temperature (T1) of a brake component and particularly preferably a first temperature curve (T1(t)) of the brake component.

7. The method according to claim 1, wherein the first simulation result is calculated with at least one first parameter for the first simulation model (S1), which is preferably a braking power (Q_{B}) and particularly preferably a braking power curve (Q_{B}(t)).

8. The method according to claim 1, wherein due to a plurality of first input variables, a plurality of second input variables is determined and from this a characteristic curve is created.

9. The method according to claim 8, wherein depending on at least one second parameter, which is entered into the first simulation model (S1) and the second simulation model (S2), a characteristic map (K) is created with first input variable and second input variable.
